(19) United States
(12) Patent Application Publication
(10) Pub. No.: US 2024/0169373 A1
(43) Pub. Date: May 23, 2024

(54) SYSTEM AND METHOD FOR AN UNIFIED FRAMEWORK TO COLLECT, VALIDATE AND DISTRIBUTE EXPLICIT AND IMPLICIT FEEDBACK FROM ANY SOFTWARE SYSTEM

(71) Applicant: JPMorgan Chase Bank, N.A., New York, NY (US)

(72) Inventors: Abhishek MITRA, Bangalore (IN); Balasubramanian DHAKSHINAMOORTHY, Bengaluru (IN); Chad LAVY, Delaware, OH (US); Parveza RAHMAN, New Albany, OH (US); Ilan SELINGER, Walnut Creek, CA (US)

(73) Assignee: JPMorgan Chase Bank, N.A., New York, NY (US)

(21) Appl. No.: 18/092,670

(22) Filed: Jan. 3, 2023

(30) Foreign Application Priority Data
Nov. 18, 2022 (IN) 202211066208

(51) Int. Cl. G06Q 30/0201; G06F 16/21; G06F 16/2455

(52) U.S. Cl. CPC G06Q 30/0201; G06F 16/211; G06F 16/24564

(57) ABSTRACT

Various methods, apparatuses/systems, and media for implementing a unified framework for collecting, processing, enriching, validating, and distributing explicit and implicit feedback of all types from any software application agnostic to use case and contexts are disclosed. A processor receives a query from an application to collect feedback data from a particular field within an ontology that includes mapping of application level details where all fields are being used in capturing data; analyzes the query and traverses up ontology branches of an ontology structure of the ontology to create one or more feedback collection schemas based on the received query; collects the feedback data from the particular field based on the one or more feedback collection schemas; assigns the collected feedback data an event under a topic for consumption so that an end user can subscribe to the event and consume the feedback data under the topic as desired.

### CROSS-REFERENCE TO RELATED APPLICATIONS

This application claims the benefit of priority from Indian Patent Application No. 202211066208, filed Nov. 18, 2022, which is herein incorporated by reference in its entirety.

### TECHNICAL FIELD

This disclosure generally relates to data processing, and, more particularly, to methods and apparatuses for implementing a platform and language agnostic unified framework configured to collect, process, enrich, validate, and distribute explicit and implicit feedback of all types from any software application agnostic to use case and contexts.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Today, a wide variety of business functions are commonly supported by software applications and tools, i.e., business intelligence (BI) tools. For instance, software has been directed to data processing, data migration, monitoring, performance analysis, project tracking, and competitive analysis, to name but a few. As software application becomes increasingly more complex, development, test, release, and management of such software application also become more complex as a large number of unique combinations of paths and modules may be tested, released, and managed for each software application. Feedback may prove to be a key element to improving the performance, quality, and adoption of software systems. Software systems may collect feedback about performance, user experience, data exhibits, visualizations, machine learning (ML) or artificial intelligence (AI) based solution such as recommendations, predictions, segmentations, etc.

Feedback may broadly be classified in two forms (1) explicit and (2) implicit. Explicit feedback is where it is open to the end user. For example, explicit feedback may refer to the mode of feedback collection in which user is directly and knowingly providing the feedback about a specific item visible to her. Implicit feedback is where users are just clicking through certain things, i.e., users' actions and behaviors in the backend is determined if it is a positive experience or a negative experience. For example, implicit feedback may refer to the mode of feedback collection where feedback is derived from user behavior on an application and/or data exhibits on an application.

Conventional feedback solutions (i.e., collection, distribution, context enrichment, validation,) have been siloed. For example, the feedback system for user experience is different from that of data quality correction or that of our machine learning solutions. Today, there appears to be no single framework to unify these systems or solutions. For example, regarding collection aspect of the feedback solutions, the lack of a unified framework causes application development teams to develop different tooling and processes to manage their feedback system. Democratizing feedback may prove to be very powerful for success of a software system. Regarding distribution aspect of the feedback solutions, the lack of a unified framework prevents the democratization of feedback. Thus, applications, user, etc. may be forced to consume feedback from feedback sources with disparate methodologies. Regarding the context enrichment aspect of the software solutions, siloed systems lack systematic methods of capturing feedback and relevant contextual information or metadata. In most systems these contents and their contexts may be captured based on specific use cases, and therefore lacking generalization and scalability. Regarding validation aspect of the software solutions, conventional systems lack a standard framework for feedback validation which can result in inducing bias and/or noise into the system if unchecked. Moreover, the lack of a unified framework makes validation unscalable.

Therefore, there is a need for an advanced tool that can address these conventional shortcomings.

### SUMMARY

The present disclosure, through one or more of its various aspects, embodiments, and/or specific features or sub-components, provides, among other features, various systems, servers, devices, methods, media, programs, and platforms for implementing a platform and language agnostic unified framework module configured to collect, process, enrich, validate, and distribute explicit and implicit feedback of all types from any software application agnostic to use case and contexts, but the disclosure is not limited thereto.

For example, the present disclosure, through one or more of its various aspects, embodiments, and/or specific features or sub-components, provides, among other features, various systems, servers, devices, methods, media, programs, and platforms for implementing a platform and language agnostic unified framework module configured to create a framework that systematically builds context for all feedback collected; give feedback collectors and processors tools to configure the depth of context based on the demands of their use cases; support mandatory and optional feedback content that is configurable by the collector or the processor; provide flexible feedback validation solutions (i e, manual, rules-based, ML/AI-based (to reduce biases)); introduce distributed manual review feedback workflows; provide an ecosystem where feedback data can be compared against external reference data before being decided upon; make feedback available in real time while allowing consumers to process them in any mode i.e., real time, batch etc., but the disclosure is not limited thereto.

According to an aspect of the present disclosure, a method for implementing a unified framework module by utilizing one or more processors along with allocated memory is disclosed. The method may include: creating an ontology that includes mapping of application level details where all fields are being used in capturing data; encoding each field's contextual information using an ontology structure surrounding the field in the ontology; receiving a query from an application to collect feedback data from a particular field within the ontology; analyzing the query and traversing up ontology branches of the ontology structure to create one or more feedback collection schemas to allow rich context collection based on the received query; collecting the feedback data from the particular field based on the one or more feedback collection schemas; assigning the collected feedback data an event under a topic for consumption; and subscribing to the event and consuming the feedback data under the topic as requested by an end user.

According to a further aspect of the present disclosure, the method may further include: generating a machine learning model that learns a set of features and a list of fields that allow the end user to provide input regarding additional fields the end user wants to see corresponding to the application.

According to another aspect of the present disclosure, the method may further include: curating and maintaining a set of fields that the end user wants to see in a predefined tabular view.

According to yet another aspect of the present disclosure, the method may further include: receiving inputs that mention the set of fields and corresponding chart or view or analysis the end user wants to see.

According to an aspect of the present disclosure, the method may further include: collecting the feedback data for a predefined domain based on the one or more feedback collection schemas.

According to a further aspect of the present disclosure, the application or sub-application may utilize the one or more of feedback collection schemas based on the domain of the feedback collected under a specific context.

According to another aspect of the present disclosure, the specific context may include one or more of the following contexts: ontology based context, application context, and personal context, but the disclosure is not limited thereto.

According to yet another aspect of the present disclosure, the method may further include: validating the feedback data by implementing one or more of the following validation processes: manual validation process; rule based validation process; and artificial intelligence or machine learning based process, but the disclosure is not limited thereto.

According to a further aspect of the present disclosure, the method may further include: implementing the unified framework module in a manner such that the unified framework module is configured to collect, process, enrich, validate, and distribute explicit and implicit feedback of all types from a plurality of applications agnostic to use case and contexts.

According to an aspect of the present disclosure, a system for implementing a unified framework module is disclosed. The system may include: a processor; and a memory operatively connected to the processor via a communication interface, the memory storing computer readable instructions, when executed, may cause the processor to: create an ontology that includes mapping of application level details where all fields are being used in capturing data; encode each field's contextual information using an ontology structure surrounding the field in the ontology; receive a query from an application to collect feedback data from a particular field within the ontology; analyze the query and traverse up ontology branches of the ontology structure to create one or more feedback collection schemas to allow rich context collection based on the received query; collect the feedback data from the particular field based on the one or more feedback collection schemas; assign the collected feedback data an event under a topic for consumption; and subscribe to the event and consume the feedback data under the topic as requested by an end user.

According to a further aspect of the present disclosure, the processor is further configured to: generate a machine learning model that learns a set of features and a list of fields that allow the end user to provide input regarding additional fields the end user wants to see corresponding to the application.

According to another aspect of the present disclosure, the processor is further configured to: curate and maintain a set of fields that the end user wants to see in a predefined tabular view.

According to yet another aspect of the present disclosure, the processor is further configured to: receive inputs that mention the set of fields and corresponding chart or view or analysis the end user wants to see.

According to an aspect of the present disclosure, the processor is further configured to: collect the feedback data for a predefined domain based on the one or more feedback collection schemas.

According to yet another aspect of the present disclosure, the processor is further configured to: validate the feedback data by implementing one or more of the following validation processes: manual validation process; rule based validation process; and artificial intelligence or machine learning based process, but the disclosure is not limited thereto.

According to a further aspect of the present disclosure, the processor is further configured to: implement the unified framework module in a manner such that the unified framework module is configured to collect, process, enrich, validate, and distribute explicit and implicit feedback of all types from a plurality of applications agnostic to use case and contexts.

According to an aspect of the present disclosure, a non-transitory computer readable medium configured to store instructions for implementing a unified framework module is disclosed. The instructions, when executed, may cause a processor to perform the following: creating an ontology that includes mapping of application level details where all fields are being used in capturing data; encoding each field's contextual information using an ontology structure surrounding the field in the ontology; receiving a query from an application to collect feedback data from a particular field within the ontology; analyzing the query and traversing up ontology branches of the ontology structure to create one or more feedback collection schemas to allow rich context collection based on the received query; collecting the feedback data from the particular field based on the one or more feedback collection schemas; assigning the collected feedback data an event under a topic for consumption; and subscribing to the event and consuming the feedback data under the topic as requested by an end user.

According to a further aspect of the present disclosure, the instructions, when executed, may cause the processor to further perform the following: generating a machine learning model that learns a set of features and a list of fields that allow the end user to provide input regarding additional fields the end user wants to see corresponding to the application.

According to another aspect of the present disclosure, the instructions, when executed, may cause the processor to further perform the following: curating and maintaining a set of fields that the end user wants to see in a predefined tabular view.

According to yet another aspect of the present disclosure, the instructions, when executed, may cause the processor to further perform the following: receiving inputs that mention the set of fields and corresponding chart or view or analysis the end user wants to see.

According to an aspect of the present disclosure, the instructions, when executed, may cause the processor to further perform the following: collecting the feedback data for a predefined domain based on the one or more feedback collection schemas.

According to yet another aspect of the present disclosure, the instructions, when executed, may cause the processor to further perform the following: validating the feedback data by implementing one or more of the following validation processes manual validation process; rule based validation process; and artificial intelligence or machine learning based process, but the disclosure is not limited thereto.

According to a further aspect of the present disclosure, the instructions, when executed, may cause the processor to further perform the following: implementing the unified framework module in a manner such that the unified framework module is configured to collect, process, enrich, validate, and distribute explicit and implicit feedback of all types from a plurality of applications agnostic to use case and contexts.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform and language agnostic unified framework module configured to collect, process, enrich, validate, and distribute explicit and implicit feedback of all types from any software application agnostic to use case and contexts in accordance with an exemplary embodiment.

FIG. 2 illustrates an exemplary diagram of a network environment with a platform and language agnostic unified framework device in accordance with an exemplary embodiment.

FIG. 3 illustrates a system diagram for implementing a platform and language agnostic unified framework module in accordance with an exemplary embodiment.

FIG. 4 illustrates a system diagram for implementing a platform and language agnostic unified framework module of FIG. 3 in accordance with an exemplary embodiment.

FIG. 5 illustrates an exemplary flow chart implemented by the platform and language agnostic unified framework module of FIG. 4 in accordance with an exemplary embodiment.

FIG. 6 illustrates an exemplary enterprise ontology and taxonomy implemented by the platform and language agnostic unified framework module of FIG. 4 in accordance with an exemplary embodiment.

FIG. 7 illustrates another exemplary enterprise ontology implemented by the platform and language agnostic unified framework module of FIG. 4 in accordance with an exemplary embodiment.

FIG. 8 illustrates exemplary reference feeds implemented by the platform and language agnostic unified framework module of FIG. 4 in accordance with an exemplary embodiment.

FIG. 9 illustrates an exemplary feedback schema catalog implemented by the platform and language agnostic unified framework module of FIG. 4 in accordance with an exemplary embodiment.

FIG. 10 illustrates an exemplary explicit feedback data implemented by the platform and language agnostic unified framework module of FIG. 4 in accordance with an exemplary embodiment.

FIG. 11 illustrates another exemplary explicit feedback data implemented by the platform and language agnostic unified framework module of FIG. 4 in accordance with an exemplary embodiment.

FIG. 12 illustrates exemplary implicit feedback data implemented by the platform and language agnostic unified framework module of FIG. 4 in accordance with an exemplary embodiment.

FIG. 13 illustrates an exemplary publish and subscribe model implemented by the platform and language agnostic unified framework module of FIG. 4 in accordance with an exemplary embodiment.

FIG. 14A illustrates an exemplary table for manual validation and republication implemented by the platform and language agnostic unified framework module of FIG. 4 in accordance with an exemplary embodiment.

FIG. 14B illustrates an exemplary table for ruled based validation and republication implemented by the platform and language agnostic unified framework module of FIG. 4 in accordance with an exemplary embodiment.

FIG. 14C illustrates an exemplary table for AI/ML based validation and republication implemented by the platform and language agnostic unified framework module of FIG. 4 in accordance with an exemplary embodiment.

FIG. 15 illustrates an exemplary table for validation against external reference datasets implemented by the platform and language agnostic unified framework module of FIG. 4 in accordance with an exemplary embodiment.

FIG. 16 illustrates an exemplary manual validation workflow implemented by the platform and language agnostic unified framework module of FIG. 4 in accordance with an exemplary embodiment.

FIG. 17 illustrates an exemplary consumption workflow implemented by the platform and language agnostic unified framework module of FIG. 4 in accordance with an exemplary embodiment.

FIG. 18 illustrates an exemplary flow chart implemented by the platform and language agnostic unified framework module of FIG. 4 for collecting, processing, enriching, validating, and distributing explicit and implicit feedback of all types from any software application agnostic to use case and contexts in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

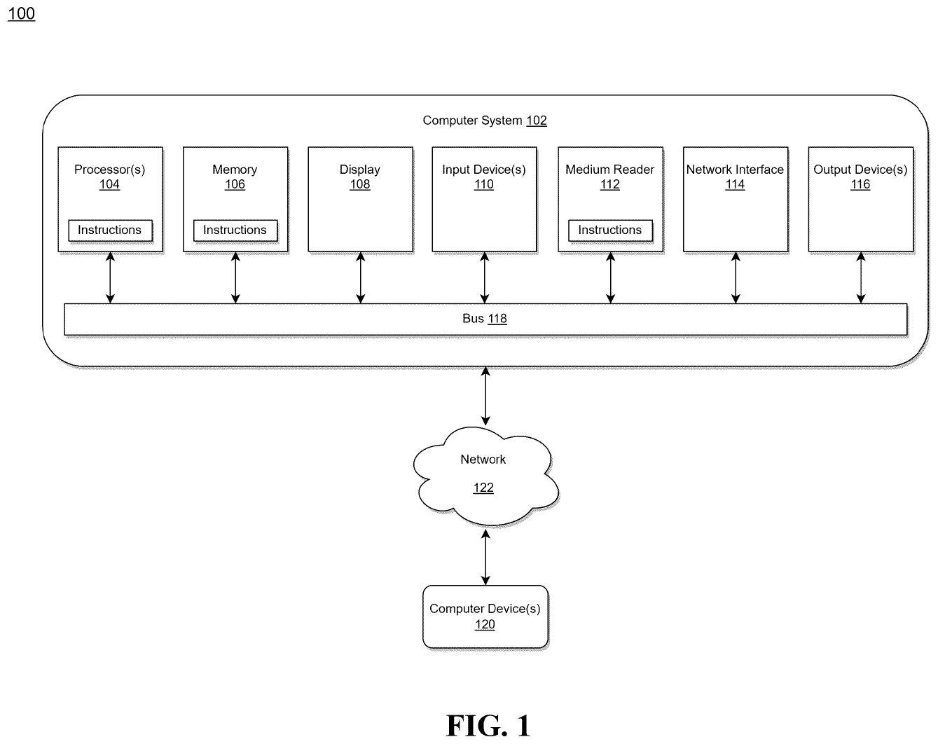

FIG. 1 is an exemplary system 100 for use in implementing a platform and language agnostic unified framework module configured to collect, process, enrich, validate, and distribute explicit and implicit feedback of all types from any software application agnostic to use case and contexts in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the data mesh module may be platform and language agnostic that may allow for consistent easy orchestration and passing of data through various components to output a desired result regardless of cloud environment. Since the disclosed process, according to exemplary embodiments, is platform and language agnostic, the data mesh module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

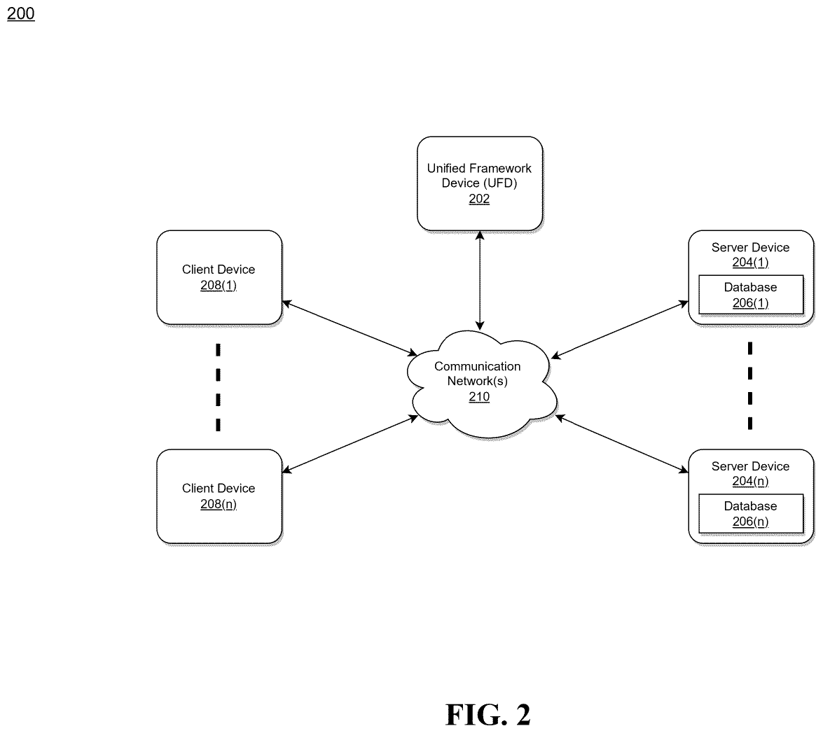

Referring to FIG. 2, a schematic of an exemplary network environment 200 for implementing a platform and language agnostic unified framework device (UFD) of the instant disclosure is illustrated.

According to exemplary embodiments, the above-described problems associated with conventional tools may be overcome by implementing a UFD 202 as illustrated in FIG. 2 that may be configured for implementing a platform and language agnostic unified framework module configured to collect, process, enrich, validate, and distribute explicit and implicit feedback of all types from any software application agnostic to use case and contexts, but the disclosure is not limited thereto.

The UFD 202 may be the same or similar to the computer system 102 as described with respect to FIG. 1.

The UFD 202 may store one or more applications that can include executable instructions that, when executed by the UFD 202, cause the UFD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the UFD 202 itself, may be located in virtual server(s) running in a cloud-based computing environment rather than being tied to one or more specific physical network computing devices. Also, the application(s) may be running in one or more virtual machines (VMs) executing on the UFD 202. Additionally, in one or more embodiments of this technology, virtual machine(s) running on the UFD 202 may be managed or supervised by a hypervisor.

In the network environment 200 of FIG. 2, the UFD 202 is coupled to a plurality of server devices 204(1)-204(n) that hosts a plurality of databases 206(1)-206(n), and also to a plurality of client devices 208(1)-208(n) via communication network(s) 210. A communication interface of the UFD 202, such as the network interface 114 of the computer system 102 of FIG. 1, operatively couples and communicates between the UFD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the UFD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The UFD 202 may be a standalone device or integrated with one or more other devices or apparatuses, such as one or more of the server devices 204(1)-204(n), for example. In one particular example, the UFD 202 may be hosted by one of the server devices 204(1)-204(n), and other arrangements are also possible. Moreover, one or more of the devices of the UFD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the UFD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the UFD 202 that may efficiently provide a platform for platform and language agnostic unified framework module configured to collect, process, enrich, validate, and distribute explicit and implicit feedback of all types from any software application agnostic to use case and contexts, but the disclosure is not limited thereto. For example, according to exemplary embodiments, the client devices 208(1)-208(n) in this example may include any type of computing device that can facilitate the implementation of the UFD 202 that may efficiently provide a platform and language agnostic unified framework module configured to create a framework that systematically builds context for all feedback collected; give feedback collectors and processors tools to configure the depth of context based on the demands of their use cases; support mandatory and optional feedback content that is configurable by the collector or the processor; provide flexible feedback validation solutions (i e, manual, rules-based, ML/AI-based (to reduce biases)); introduce distributed manual review feedback workflows; provide an ecosystem where feedback data can be compared against external reference data before being decided upon; make feedback available in real time while allowing consumers to process them in any mode i.e., real time, batch etc., but the disclosure is not limited thereto.

The client devices 208(1)-208(n) may run interface applications, such as standard web browsers or standalone client applications, which may provide an interface to communicate with the UFD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the UFD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the UFD 202, the server devices 204(1)-204(n), or the client devices 208(1)-208(n), for example, may be configured to operate as virtual instances on the same physical machine. For example, one or more of the UFD 202, the server devices 204(1)-204(n), or the client devices 208(1)-208(n) may operate on the same physical device rather than as separate devices communicating through communication network(s) 210. Additionally, there may be more or fewer UFDs 202, server devices 204(1)-204(n), or client devices 208(1)-208(n) than illustrated in FIG. 2. According to exemplary embodiments, the UFD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

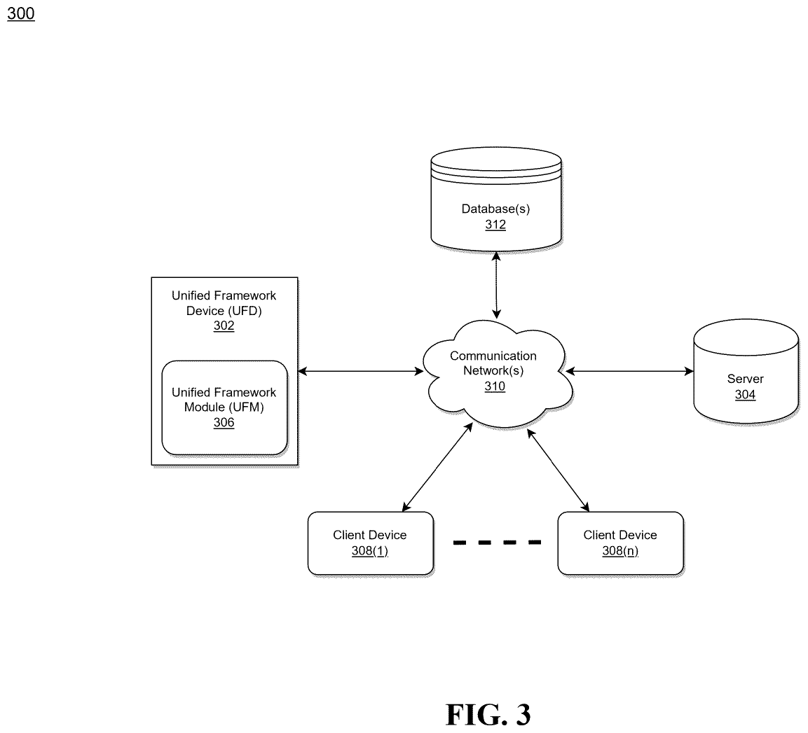

FIG. 3 illustrates a system diagram for implementing a UFD having a platform and language agnostic unified framework module (UFM) in accordance with an exemplary embodiment.

As illustrated in FIG. 3, the system 300 may include a UFD 302 within which an UFM 306 is embedded, a server 304, a database(s) 312, a plurality of client devices 308(1) . . . 308(n), and a communication network 310.

According to exemplary embodiments, the UFD 302 including the UFM 306 may be connected to the server 304, and the database(s) 312 via the communication network 310. The UFD 302 may also be connected to the plurality of client devices 308(1) . . . 308(n) via the communication network 310, but the disclosure is not limited thereto.

According to exemplary embodiment, the UFD 302 is described and shown in FIG. 3 as including the UFM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) may be a mainframe database, a log database that may produce programming for searching, monitoring, and analyzing machine-generated data via a web interface, etc., but the disclosure is not limited thereto.

According to exemplary embodiments, the UFM 306 may be configured to receive real-time feed of data from the plurality of client devices 308(1) . . . 308(n) via the communication network 310.

As may be described below, the UFM 306 may be configured to: create an ontology that includes mapping of application level details where all fields are being used in capturing data; encode each field's contextual information using an ontology structure surrounding the field in the ontology; receive a query from an application to collect feedback data from a particular field within the ontology; analyze the query and traverse up ontology branches of the ontology structure to create one or more feedback collection schemas to allow rich context collection based on the received query; collect the feedback data from the particular field based on the one or more feedback collection schemas; assign the collected feedback data an event under a topic for consumption; and subscribe to the event and consume the feedback data under the topic as requested by an end user, but the disclosure is not limited thereto.

The plurality of client devices 308(1) . . . 308(n) are illustrated as being in communication with the UFD 302. In this regard, the plurality of client devices 308(1) . . . 308(n) may be “clients” (e.g., customers) of the UFD 302 and are described herein as such. Nevertheless, it is to be known and understood that the plurality of client devices 308(1) . . . 308(n) need not necessarily be “clients” of the UFD 302, or any entity described in association therewith herein. Any additional or alternative relationship may exist between either or both of the plurality of client devices 308(1) . . . 308(n) and the UFD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the UFD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The UFD 302 may be the same or similar to the UFD 202 as described with respect to FIG. 2, including any features or combination of features described with respect thereto.

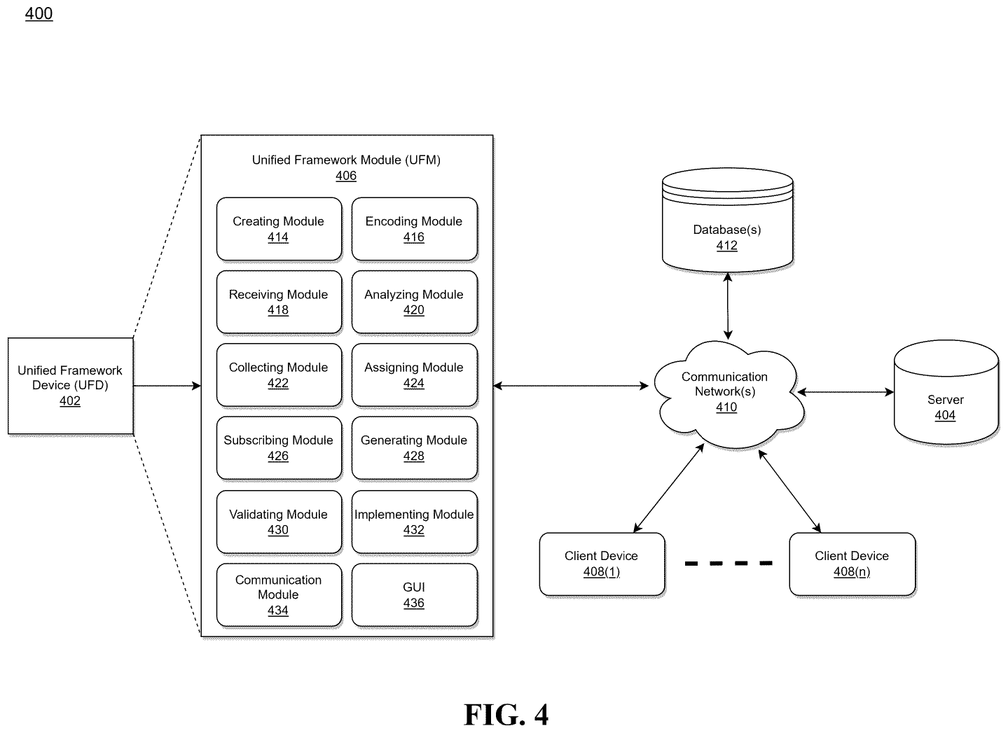

FIG. 4 illustrates a system diagram for implementing a platform and language agnostic UFM of FIG. 3 in accordance with an exemplary embodiment.

According to exemplary embodiments, the system 400 may include a platform and language agnostic UFD 402 within which a cloud agnostic UFM 406 is embedded, a server 404, database(s) 412, and a communication network 410.

According to exemplary embodiments, the UFD 402 including the UFM 406 may be connected to the server 404 and the database(s) 412 via the communication network 410. The UFD 402 may also be connected to the plurality of client devices 408(1)-408(n) via the communication network 410, but the disclosure is not limited thereto. The UFM 406, the server 404, the plurality of client devices 408(1)-408(n), the database(s) 412, the communication network 410 as illustrated in FIG. 4 may be the same or similar to the UFM 306, the server 304, the plurality of client devices 308(1)-308(n), the database(s) 312, the communication network 310, respectively, as illustrated in FIG. 3.

According to exemplary embodiments, as illustrated in FIG. 4, the UFM 406 may include a creating module 414, an encoding module 416, a receiving module 418, an analyzing module 420, a collecting module 422, an assigning module 424, a subscribing module 426, a generating module 428, a validating module 430, an implementing module 432, a communication module 434, and a graphical user interface (GUI) 436. According to exemplary embodiments, interactions and data exchange among these modules included in the UFM 406 provide the advantageous effects of the disclosed invention. Functionalities of each module of FIG. 4 may be described in detail below with reference to FIGS. 4-17.

According to exemplary embodiments, each of the creating module 414, encoding module 416, receiving module 418, analyzing module 420, collecting module 422, assigning module 424, subscribing module 426, generating module 428, validating module 430, implementing module 432, and the communication module 434 of the UFM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the creating module 414, encoding module 416, receiving module 418, analyzing module 420, collecting module 422, assigning module 424, subscribing module 426, generating module 428, validating module 430, implementing module 432, and the communication module 434 of the UFM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the creating module 414, encoding module 416, receiving module 418, analyzing module 420, collecting module 422, assigning module 424, subscribing module 426, generating module 428, validating module 430, implementing module 432, and the communication module 434 of the UFM 406 of FIG. 4 may be implemented by dedicated hardware, or as a combination of dedicated hardware to perform some functions and a processor (e.g., one or more programmed microprocessors and associated circuitry) to perform other functions.

According to exemplary embodiments, each of the creating module 414, encoding module 416, receiving module 418, analyzing module 420, collecting module 422, assigning module 424, subscribing module 426, generating module 428, validating module 430, implementing module 432, and the communication module 434 of the UFM 406 of FIG. 4 may be called via corresponding API.

According to exemplary embodiments, the process may be executed via the communication module 434 and the communication network 410, which may comprise plural networks as described above. For example, in an exemplary embodiment, the various components of the UFM 406 may communicate with the server 404, and the database(s) 412 via the communication module 434 and the communication network 410. Of course, these embodiments are merely exemplary and are not limiting or exhaustive.

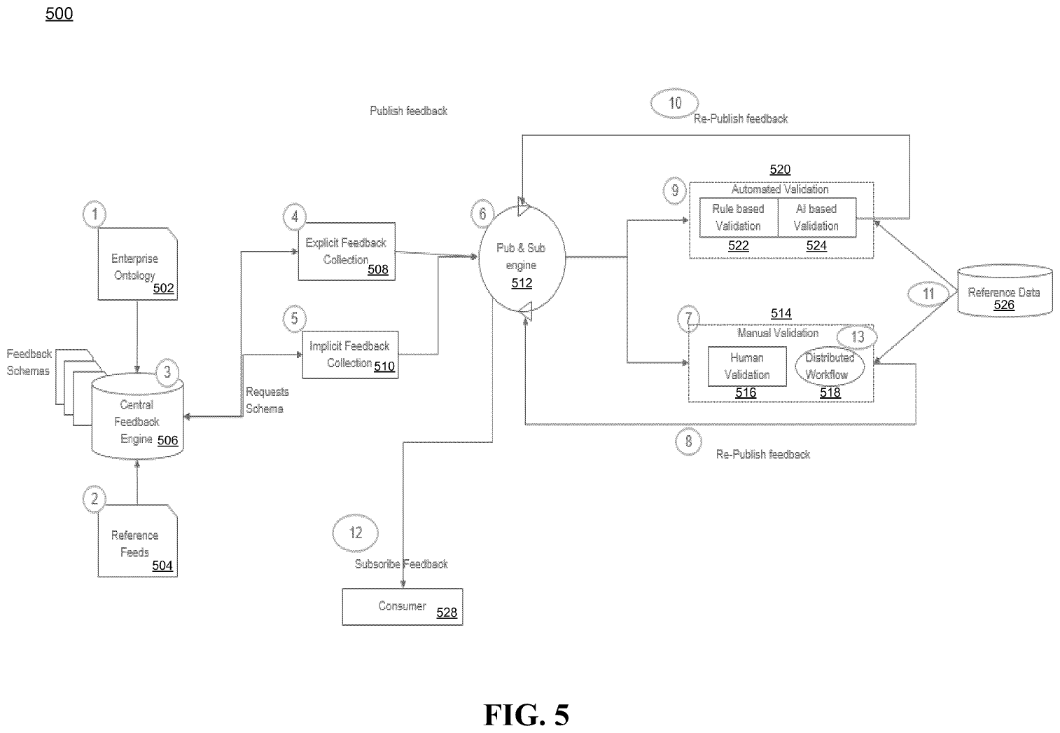

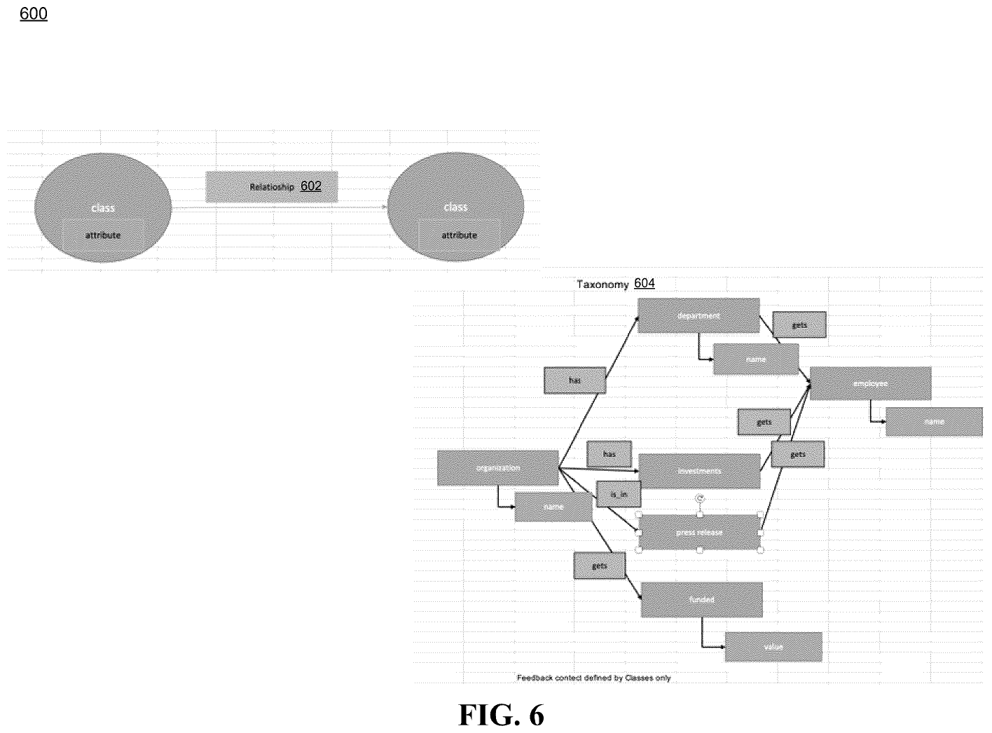

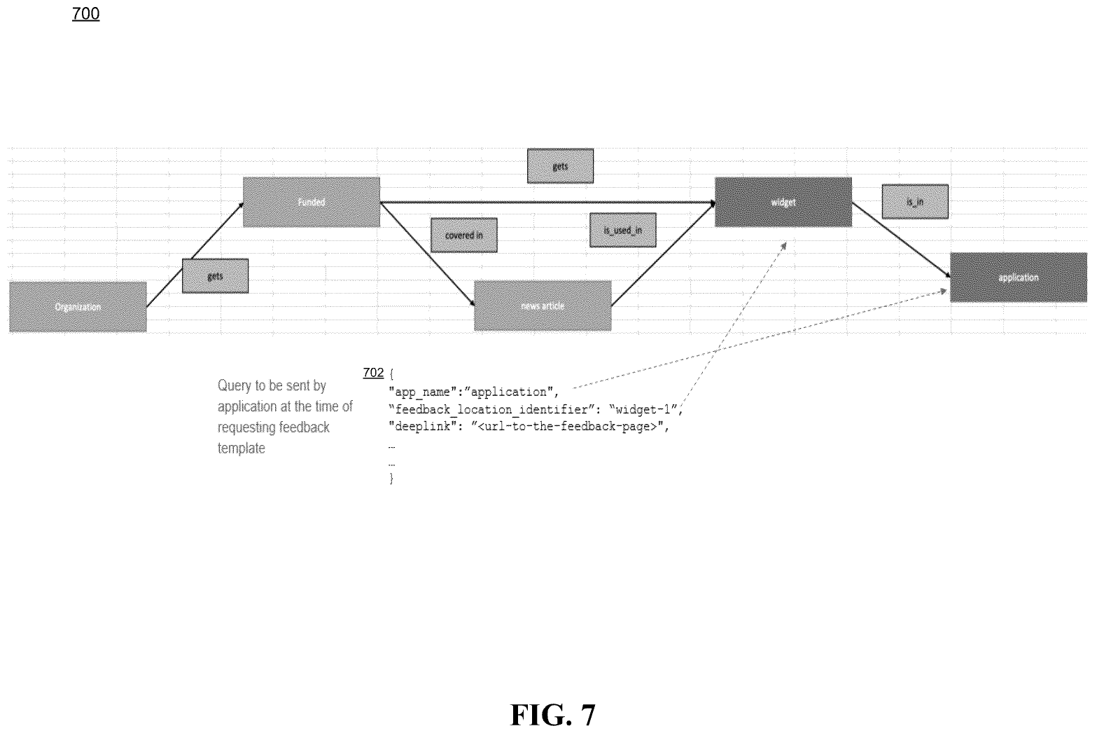

According to exemplary embodiments, the creating module 414 may be configured to create an ontology (see, e.g., element 502 in FIG. 5) that includes mapping of application level details where all fields are being used in capturing data. The encoding module 416 may be configured to encode each field's contextual information using an ontology structure (see, e.g., FIGS. 6 and 7) surrounding the field in the ontology. The receiving module 418 may be configured to receive a query from an application to collect feedback data from a particular field within the ontology. The analyzing module 420 may be configured to analyze the query and traverse up ontology branches of the ontology structure to create one or more feedback collection schemas to allow rich context collection based on the received query. The feedback collection schemas may be stored onto a central feedback engine (see, e.g., element 506 in FIG. 5). The collecting module 422 may be configured to collect the feedback data from the particular field based on the one or more feedback collection schemas. The assigning module 424 may be configured to assign the collected feedback data an event under a topic for consumption. The subscribing module 426 may be configured to allow a consumer or an application to subscribe to the event and consume the feedback data under the topic as requested by an end user.

According to exemplary embodiments, the generating module 428 may be configured to generate a machine learning model that learns a set of features and a list of fields that allow the end user to provide input regarding additional fields the end user wants to see corresponding to the application.

According to exemplary embodiments, the UFM 406 may be configured to allow curating and maintaining a set of fields that the end user wants to see in a predefined tabular view and display on to the GUI 436.

According to exemplary embodiments, the receiving module 418 may be configured to receive inputs that mention the set of fields and corresponding chart or view or analysis the end user wants to see on the GUI 436.

According to exemplary embodiments, the collecting module 422 may be configured to collect the feedback data for a predefined domain based on the one or more feedback collection schemas.

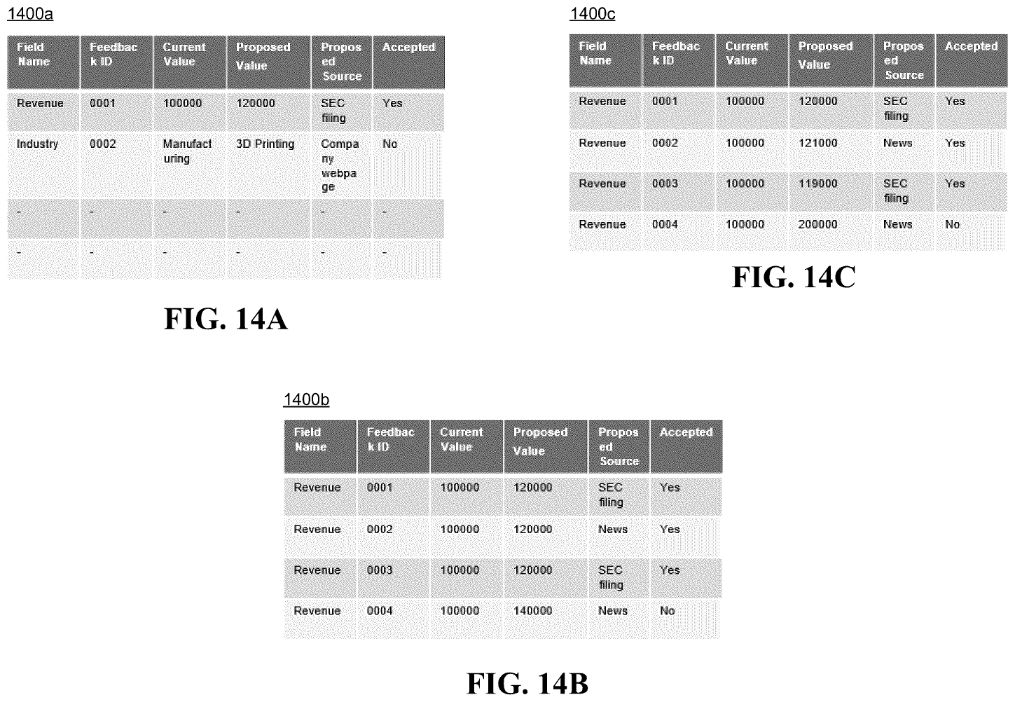

According to exemplary embodiments, the validating module 430 may be configured to validate the feedback data by implementing one or more of the following validation processes: manual validation process (see FIG. 14A); rule based validation process (see FIG. 14B); and artificial intelligence or machine learning (AI/ML) based process (see FIG. 14C), but the disclosure is not limited thereto.

According to exemplary embodiments, the implementing module 432 may be configured to implement the unified framework module in a manner such that the unified framework module is configured to collect, process, enrich, validate, and distribute explicit and implicit feedback of all types from a plurality of applications agnostic to use case and contexts (see, e.g., FIGS. 5-17).

FIG. 5 illustrates an exemplary flow chart 500 implemented by the platform and language agnostic UFM 406 module of FIG. 4 in accordance with an exemplary embodiment. FIG. 6 illustrates an exemplary enterprise ontology 600 and taxonomy implemented by the platform and language agnostic unified framework module of FIG. 4 in accordance with an exemplary embodiment. FIG. 7 illustrates another exemplary enterprise ontology 700 implemented by the platform and language agnostic UFM 406 of FIG. 4 in accordance with an exemplary embodiment.

Referring back to FIGS. 4-7, as illustrated in FIG. 5, at step 1, enterprise ontology 502, 600, 700 may be created. According to exemplary embodiments, the enterprise ontology 502, 600, 700 may encompass a representation, formal naming, and definition of the categories, properties, and relations between the concepts, data, and entities that substantiate one, many, or all domains of discourse. According to exemplary embodiments, the enterprise ontology 502, 600, 700 illustrates a way of showing the properties of a subject area and how they are related, by defining a set of concepts and categories that represent the subject. In this regard, in the application, a glossary of all fields for which data is captures is maintained/stored in a database (i.e., 412 in FIG. 4). For example, the central feedback engine 506 may receive the enterprise ontology 502, 600, 700, reference feeds 504, feedback schemas, explicit feedback data from explicit feedback collection block 508, and implicit feedback data from implicit feedback collection block 510. Documenting and hosting the relations among all fields are implemented to create the enterprise ontology 502. After collecting the feedback on a field, contextual information may be encoded by the encoding module 416 as illustrated in FIG. 4 using the ontology structure surrounding the field in the ontology 502, 600, 700.

According to exemplary embodiments, as illustrated in FIG. 6, the exemplary ontology 600 may include a relationship 602 between classes and attributes and corresponding taxonomy 604.

According to exemplary embodiments, as illustrated in FIG. 7, in the exemplary ontology 700 mapping of application level details where the fields are being used are stored onto a database (i.e., 412 in FIG. 4). When an application wants to collect feedback from a particular location within, for example, Micro, UI, Widget, Child page, etc. (but the disclosure is not limited thereto), it may query the central feedback engine 506 with these details. The central feedback engine 506 may utilize the analyzing module 420 to analyze the query and traverse up the ontology branches to create an appropriate feedback collection schema in order to allow rich context collection. As illustrated in FIG. 7, a pseudo code 702 is generated that can be utilized by the application at the time of requesting feedback template.

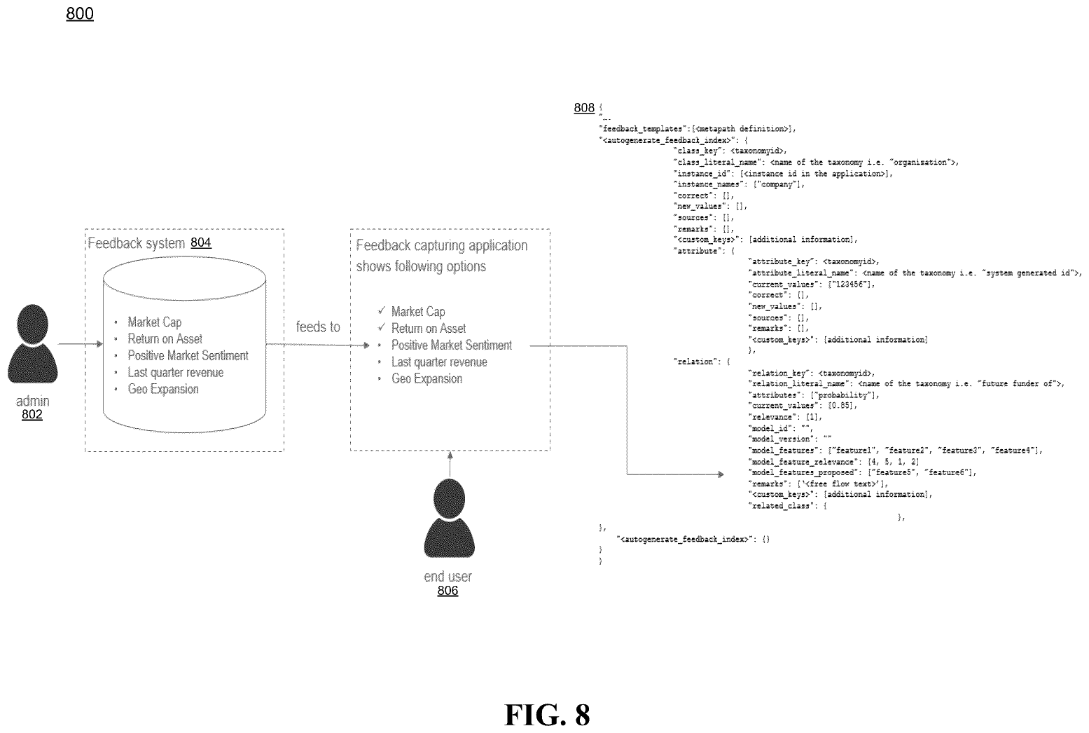

As illustrated in FIG. 5, reference feeds 504 may be obtained by the central feedback engine 506 at step 2. FIG. 8 illustrates exemplary reference feeds 800 implemented by the platform and language agnostic UFM 406 of FIG. 4 in accordance with an exemplary embodiment. As illustrated in FIG. 8, feedback system 804, may receive input from administrator 802. The input may include market cap data, return on asset data, positive market sentiment data, last quarter revenue data, geo expansion data, but the disclosure is not limited thereto. As illustrated in FIG. 8, a pseudo code 808 is generated that can be utilized by the application at the time of feedback capturing. The end user 806 may consume the feedback data. In an exemplary use case, feedback capturing application shows following options: market cap data and return on asset data, but the disclosure is not limited thereto.

According to exemplary embodiments, in order to make feedback system more user friendly, the UFM 406 is configured to provide an admin capability to applications owners, business teams and other subject matter experts (SMEs). Using these admin capabilities, they can provide additional information for end users 806 to make feedback providing experience more friendlier. An example of admin capability could be an ability to curate and maintain a set of features/list of fields that can help an end user to provide input regarding additional fields he/she may want to see in an AI/ML model. Another example could be an ability for admin to curate and maintain a set of fields that an end user 806 may want to see in a particular tabular view. Another example could be mentioning a set of fields and corresponding chart/view/analysis an end user 806 may want to see.

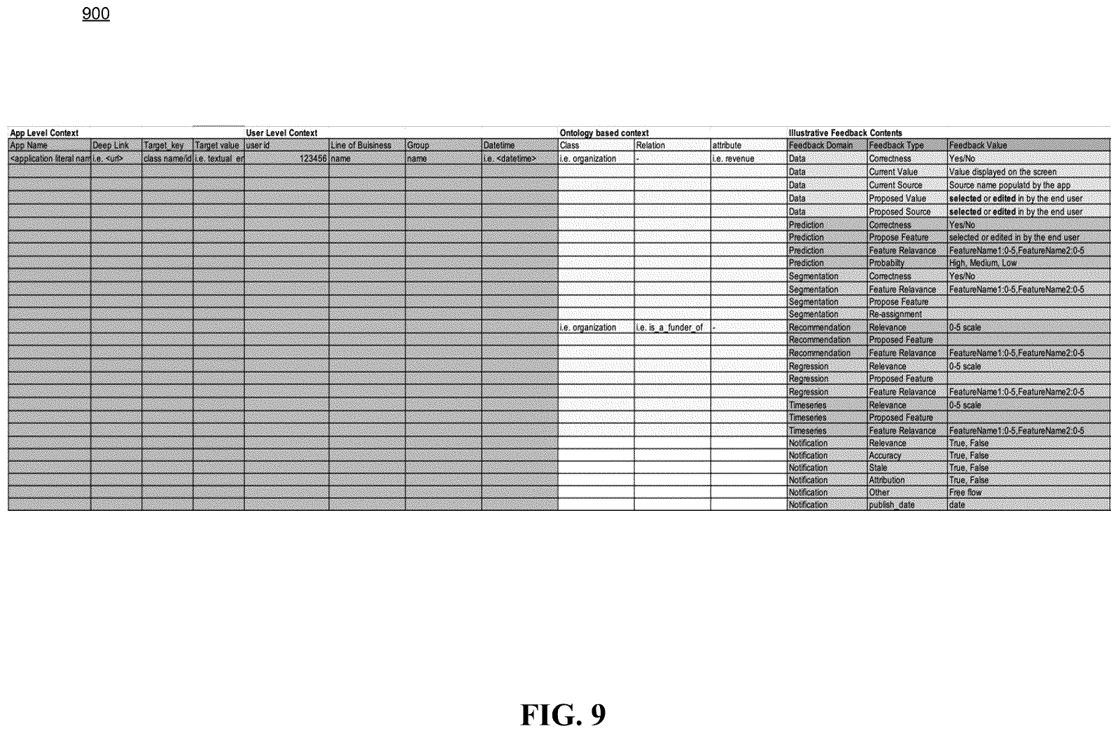

FIG. 9 illustrates an exemplary feedback schema catalog 900 implemented by the platform and language agnostic UFM 406 of FIG. 4 in accordance with an exemplary embodiment. The feedback schema catalog 900 is a repository of schemas focused on collecting feedback for a very specific domain. An application or sub application can utilize one or more of these schemas based on the domain of the feedback collected under a specific context. According to exemplary embodiments, there may be several types of contexts 1) Ontology based context, 2) Application context, 3) Personal Context etc., but the disclosure is not limited thereto. Each of the ontology item, entity, property, or relation may belong to some abstract domain of feedback (i.e., data, user experience, machine learning model etc., but the disclosure is not limited thereto). The feedback collector application can indicate the composition of its feedback content based different layers of context. The template generator within feedback system may compose it in real time and send back to collector with an appropriate data collection structure. In addition, the feedback collection templates are crowdsourced. The admin, applications, SME all can contribute fresh templates or enhancements to the catalog 900.

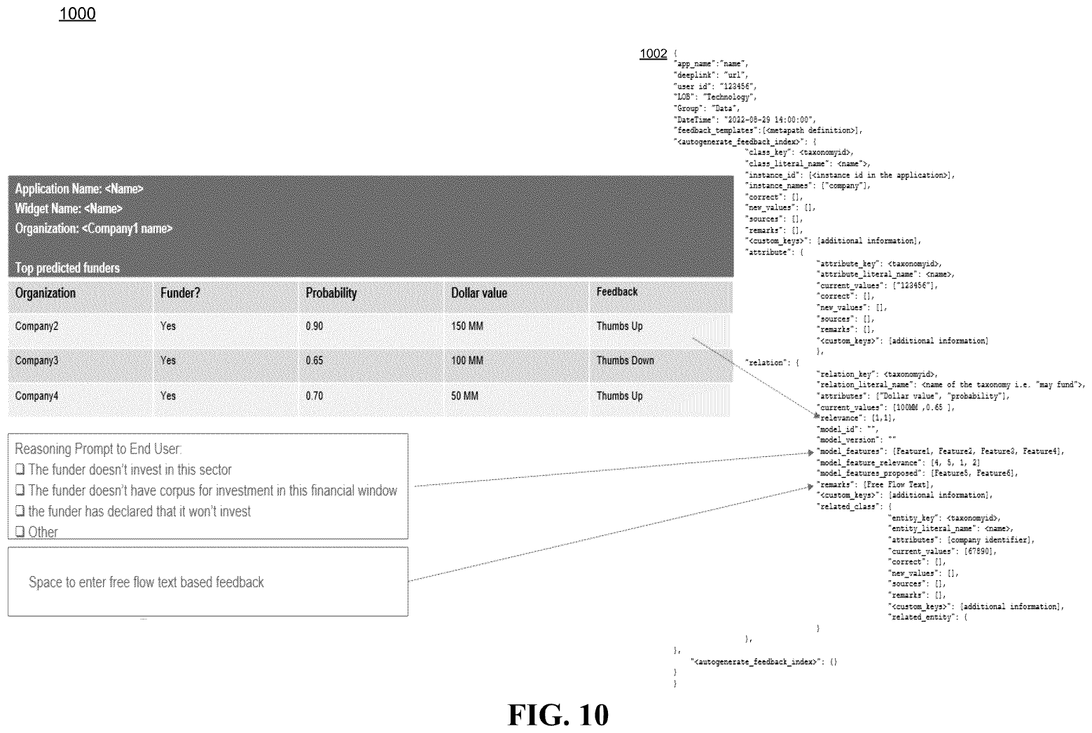

FIG. 10 illustrates an exemplary explicit feedback data 1000 implemented by the platform and language agnostic UFM 406 of FIG. 4 in accordance with an exemplary embodiment. Referring back to FIG. 5, at step 4, the collecting module 422 may be configured to collect the explicit feedback data from the explicit feedback collection block 508. According to exemplary embodiments, the explicit feedback data 1000 refers to the mode of feedback collection in which user is directly and knowingly providing the feedback about a specific item visible to her. The explicit feedback data 1000 illustrated in FIG. 10 may involve the machine learning model described above. An exemplary pseudo code 1002 may be generated by the UFM 406 that can be utilized for providing configurable multiple different modes of providing feedback data. For example, an icon based switch (i.e., thumbs up or thumbs down); check box based answers to canned questions; an option to type feedback in free flow text; an option to provide feedback with speech, etc., but disclosure is not limited thereto.

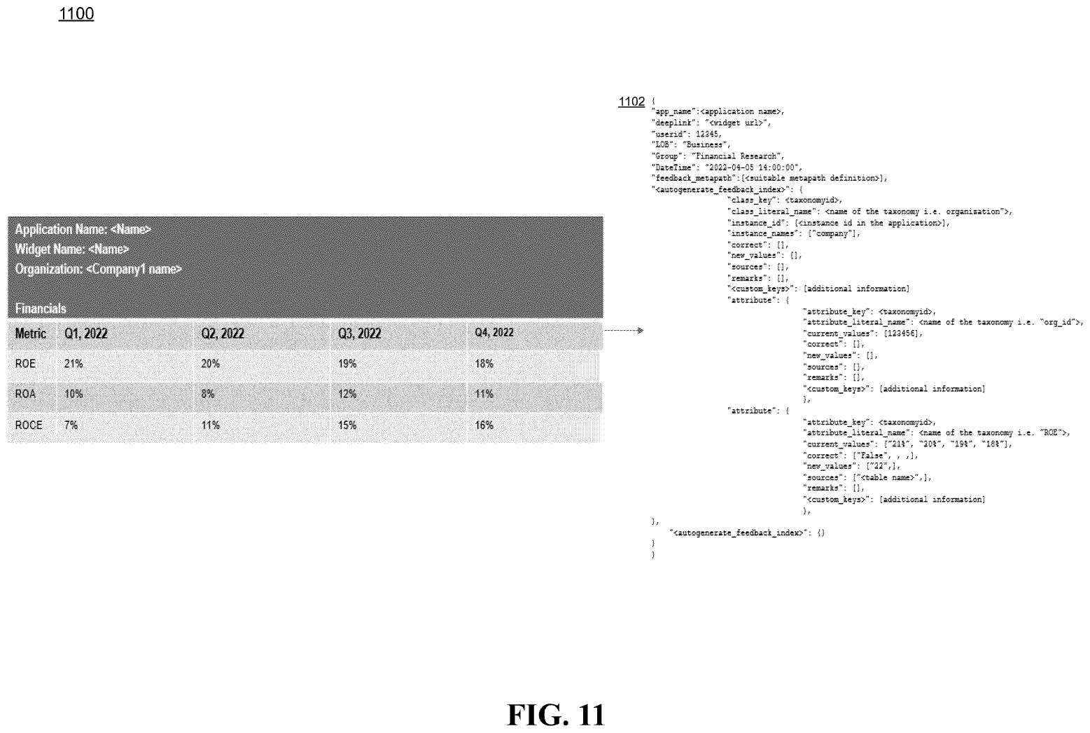

FIG. 11 illustrates another exemplary explicit feedback data 1100 implemented by the platform and language agnostic UFM 406 of FIG. 4 in accordance with an exemplary embodiment. An exemplary pseudo code 1102 may be generated by the UFM 406 that can be utilized for providing configurable multiple different modes of providing feedback data for this explicit feedback data 1100.

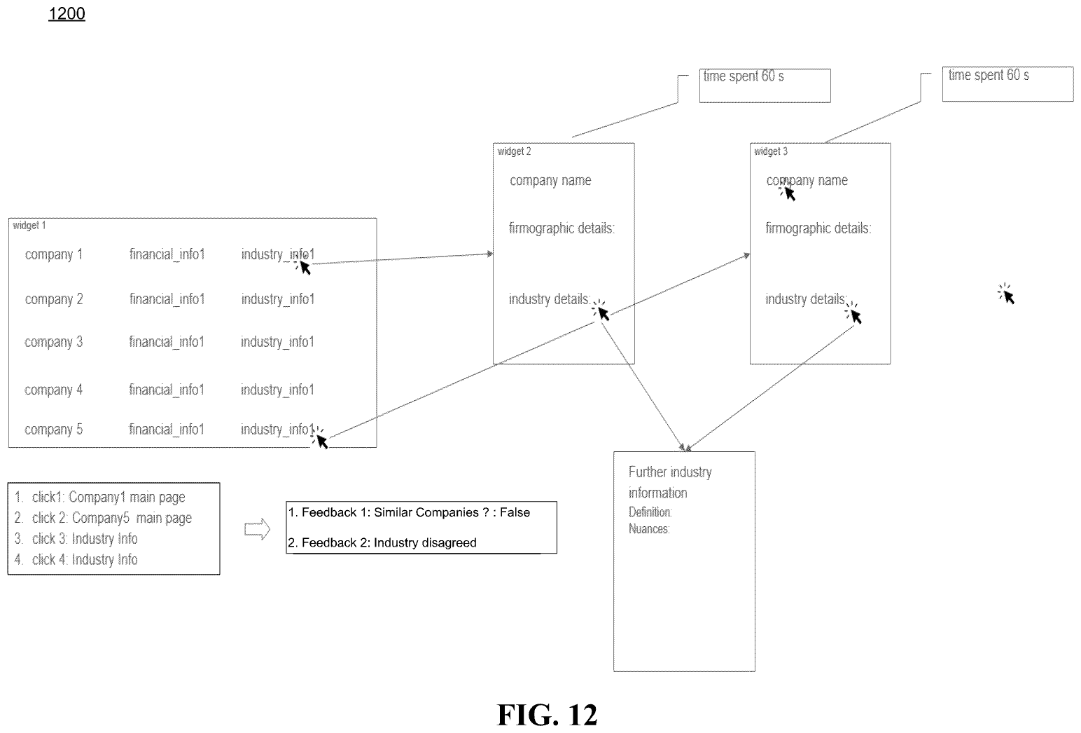

FIG. 12 illustrates exemplary implicit feedback data 1200 implemented by the platform and language agnostic UFM 406 of FIG. 4 in accordance with an exemplary embodiment. Referring back to FIG. 5, at step 5, the collecting module 422 may be configured to collect the implicit feedback data from the implicit feedback collection block 510. The implicit feedback data 1200 may refer to the mode of feedback collection where feedback is derived from user behavior on an application and data exhibits on an application, but the disclosure is not limited thereto. For example, as illustrated in FIG. 12, for click1: Company 1 main page; click 2: Company 5 main page; click 3: Industry Info; click 4: Industry Info, the UFM 406 may output Feedback 1: Similar Companies ?: False; and Feedback 2: Industry disagreed, but the disclosure is not limited thereto.

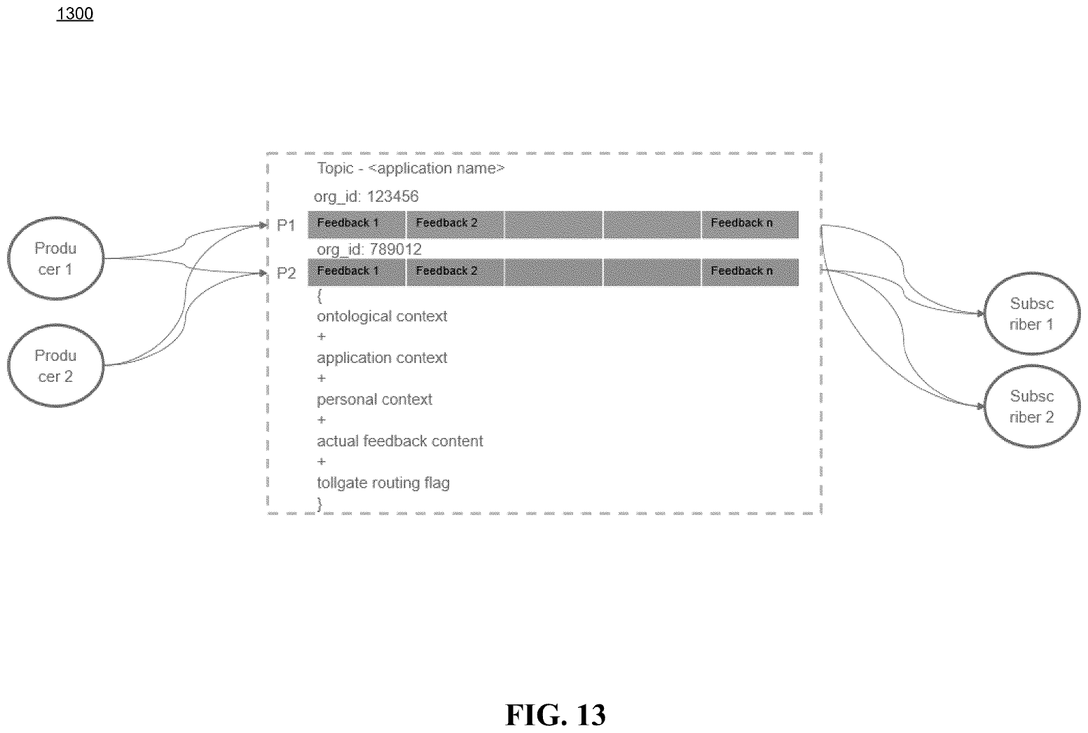

FIG. 13 illustrates an exemplary publish and subscribe model 1300 implemented by the platform and language agnostic UFM 406 of FIG. 4 in accordance with an exemplary embodiment. Referring back to FIGS. 4-5, at step 6 of FIG. 5, the UFM 406 may utilize the publication and subscription engine 512 (also subscribing module 426) to generate a publish and subscribe model 1300 as illustrated in FIG. 13. According to exemplary embodiments, the publish and subscribe model 1300 may be utilized for feedback distribution process. Every feedback may become an event under a topic. Each event may be characterized by a key, event value, event timestamp, even tollgate and other optional headers. A topic name could be <application name>; event Key could be an identifier for the feedback subject; event value may contain the complete feedback message; event timestamp may contain the time of feedback capture; event tollgate may define the type of validation tollgate the feedback message will pass before it gets consumed by the consumer 528 at step 12 of FIG. 5. An exemplary toll gate may include, for example, 1) human validation and/or 2) rule based validation and/or 3) AIML based validation.

FIG. 14A illustrates an exemplary table 1400a for manual validation and republication implemented by the platform and language agnostic UFM 406 of FIG. 4 in accordance with an exemplary embodiment. FIG. 14B illustrates an exemplary table 1400b for rule based validation and republication implemented by the platform and language agnostic UFM 406 of FIG. 4 in accordance with an exemplary embodiment. For example, rule based validation may include the following:

If count(new_values)>50% of votes:

Accept new value

else:

Reject new value.

FIG. 14C illustrates an exemplary table 1400c for AI/ML based validation and republication implemented by the platform and language agnostic UFM 406 of FIG. 4 in accordance with an exemplary embodiment. For example, the ML model may cluster outlier proposals and outliers to get rejected automatically.

According to exemplary embodiments, the validated values may be republished into the feedback distribution engine. An administrator (i.e., “admin” in short) can define which feedbacks to go through tollgate and which will not. In case of manual validation, the UFM 406 may generate a workflow tooling that may assist to distribute validation items to multiple reviewers and track those items until the validation life cycle is complete.

Referring back to FIGS. 4-5, at step 7 of FIG. 5, the validating module 430 may be configured to allow a user to perform manual validation 514 that may include validation by a human 516 or by a distributed workflow 518. At step 8, this feedback may be re-published at the publication and subscription engine 512. At step 9, automated validation 520 may be performed by the validation module 430. The automated validation 520 may include rule based validation 522 and ML/AI based validation 524. At step 10, this feedback may be re-published at the publication and subscription engine 512. At step 11, both the automated validation 520 and the manual validation 514 may utilize reference data 526 from a database (i.e., database 412).

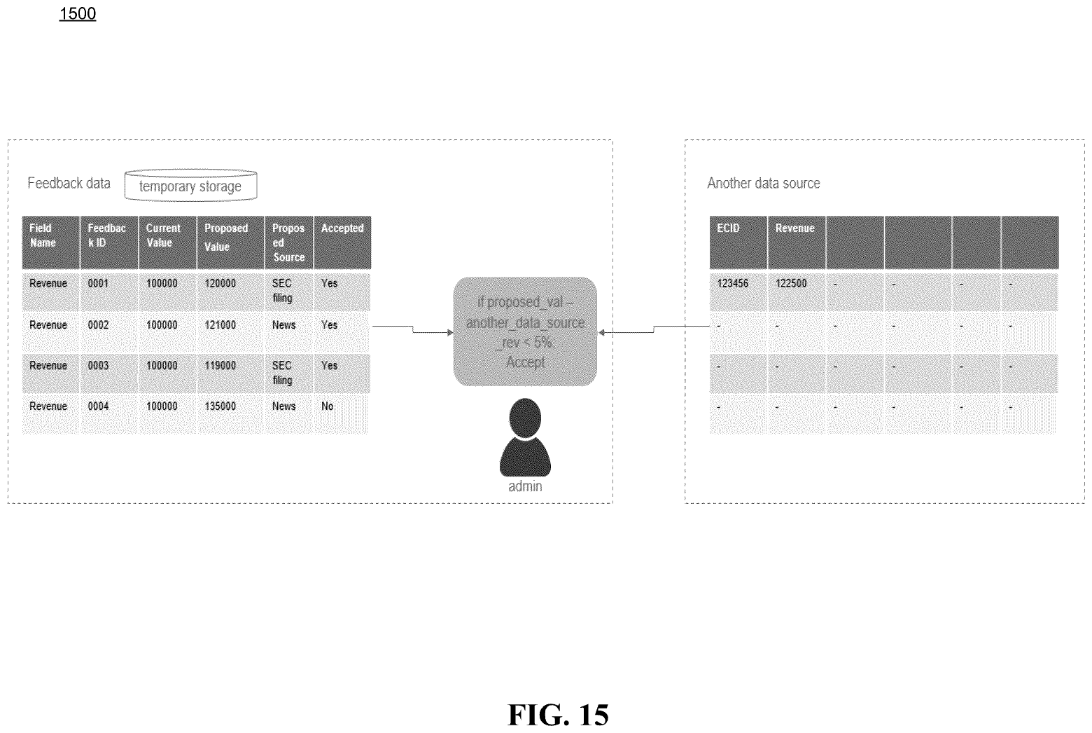

For example, FIG. 15 illustrates an exemplary table 1500 for validation against external reference datasets implemented by the platform and language agnostic UFM 406 of FIG. 4 in accordance with an exemplary embodiment. At step 12, the consumer 528 may consume/subscribe the feedback data output from the at the publication and subscription engine 512. The manual validation, i.e., human validation 516 and distributed workflow 518 may be executed at step 13 of FIG. 5. As illustrated in FIG. 15, an admin can define which data sources she/he needs for validation and feedback system will open up a way to look up those datasets i.e., API, Account Sharing etc. Feedback system also may allow an integrated development environment (IDE) to host, wrangle and analyze feedback data in conjunction with the external data.

According to exemplary embodiments, the UFM 406 may be configured to provide to the hands of an administrator (i.e., 802 in FIG. 8) is to allow designing tollgate systems for feedback quality evaluation. As described above, at least three different types of validation method, i.e., manual validation, rule based validation, AI/ML based validation, but the disclosure is not limited thereto. As described above, the validated values get republished into a feedback distribution engine (i.e., publication and subscription engine 512). The administrator 802 can define which feedbacks to go through tollgate and which will not. In case of manual validation, the UFM 406 may implement a workflow tooling that can assist to distribute validation items to multiple reviewers and track those items until the validation life cycle is complete.

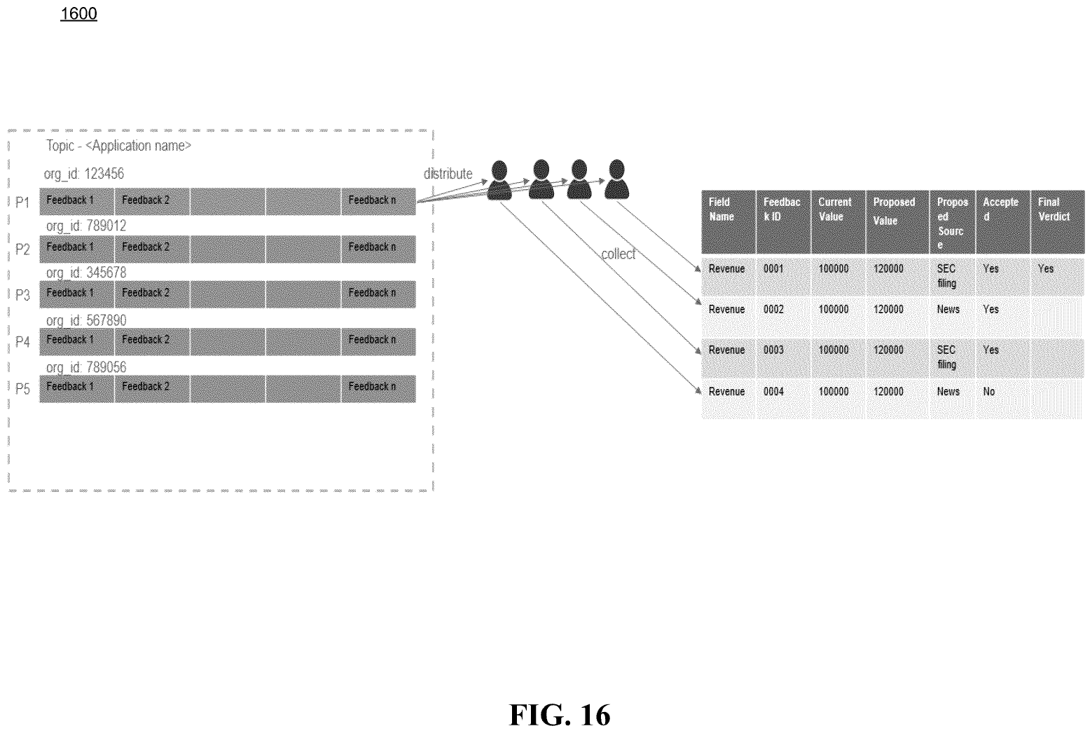

FIG. 16 illustrates an exemplary manual validation workflow 1600 implemented by the platform and language agnostic UFM 406 of FIG. 4 in accordance with an exemplary embodiment. An important aspect of validation could be to allow the administrator to validate against external reference datasets as described above in FIG. 15. The administrator can define which data sources she/he needs for validation and the UFM 406 will execute a feedback system that can open up a way to look up those datasets, i.e., API, account sharing etc., but the disclosure is not limited thereto. The feedback system executed by the UFM 406 may also allow the IDE to host, wrangle and analyze feedback data in conjunction with the external data.

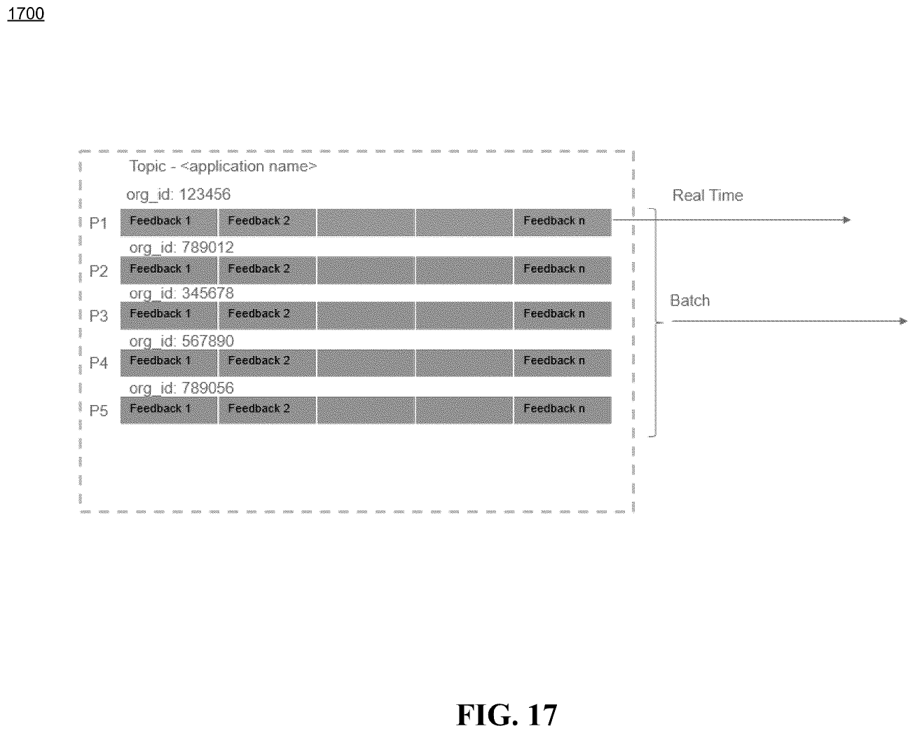

FIG. 17 illustrates an exemplary consumption workflow 1700 implemented by the platform and language agnostic UFM 406 of FIG. 4 in accordance with an exemplary embodiment. Referring back to FIG. 5, the consumer 528 has to subscribe to the topics and events. The consumer 528 can choose to consume in 1) Real time or in 2) batch, but the disclosure is not limited thereto. For example, the consumer 528 may also consume raw feedback or validated feedback, but the disclosure is not limited thereto.

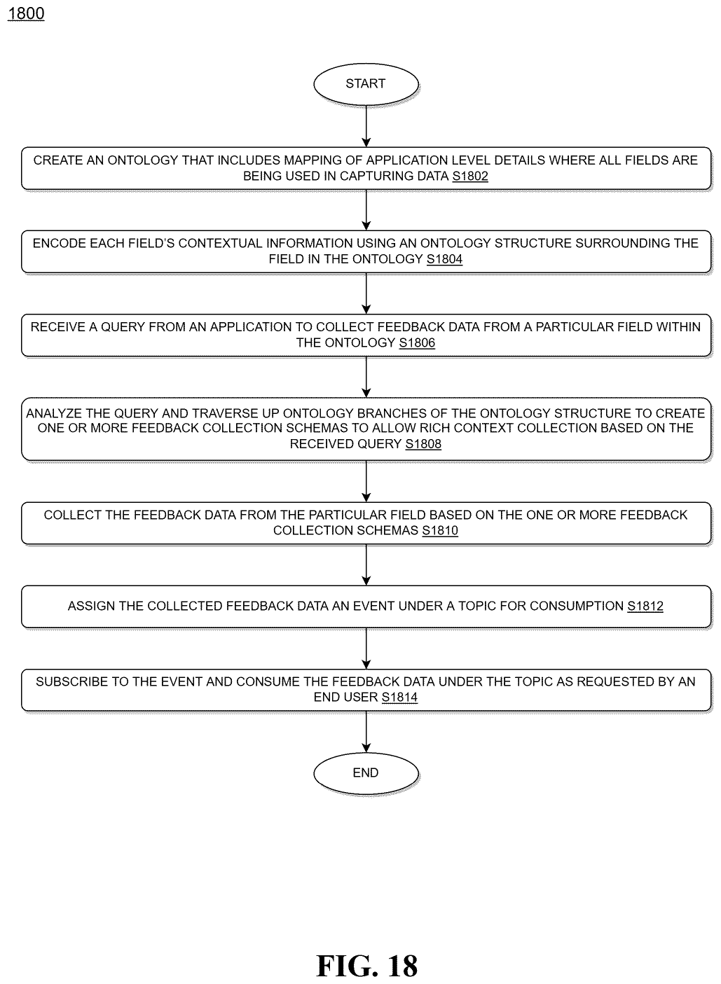

FIG. 18 illustrates an exemplary flow chart 1800 implemented by the UFM 406 of FIG. 4 for collecting, processing, enriching, validating, and distributing explicit and implicit feedback of all types from any software application agnostic to use case and contexts in accordance with an exemplary embodiment. It may be appreciated that the illustrated process 1800 and associated steps may be performed in a different order, with illustrated steps omitted, with additional steps added, or with a combination of reordered, combined, omitted, or additional steps.

As illustrated in FIG. 18, at step S1802, the process 1800 may include creating an ontology that includes mapping of application level details where all fields are being used in capturing data.

At step S1804, the process 1800 may include encoding each field's contextual information using an ontology structure surrounding the field in the ontology.

At step S1806, the process 1800 may include receiving a query from an application to collect feedback data from a particular field within the ontology.

At step S1808, the process 1800 may include analyzing the query and traversing up ontology branches of the ontology structure to create one or more feedback collection schemas to allow rich context collection based on the received query.

At step S1810, the process 1800 may include collecting the feedback data from the particular field based on the one or more feedback collection schemas.

At step S1812, the process 1800 may include assigning the collected feedback data an event under a topic for consumption.

At step S1814, the process 1800 may include subscribing to the event and consuming the feedback data under the topic as requested by an end user.

According to exemplary embodiments, the process 1800 may further include generating a machine learning model that learns a set of features and a list of fields that allow the end user to provide input regarding additional fields the end user wants to see corresponding to the application.

According to exemplary embodiments, the process 1800 may further include curating and maintaining a set of fields that the end user wants to see in a predefined tabular view.

According to exemplary embodiments, the process 1800 may further include receiving inputs that mention the set of fields and corresponding chart or view or analysis the end user wants to see.

According to exemplary embodiments, the process 1800 may further include collecting the feedback data for a predefined domain based on the one or more feedback collection schemas.

According to exemplary embodiments, in the process 1800, the application or sub-application may utilize the one or more of feedback collection schemas based on the domain of the feedback collected under a specific context.

According to exemplary embodiments, in the process 1800, the specific context may include one or more of the following contexts: ontology based context, application context, and personal context, but the disclosure is not limited thereto.

According to exemplary embodiments, the process 1800 may further include validating the feedback data by implementing one or more of the following validation processes: manual validation process; rule based validation process; and artificial intelligence or machine learning based process, but the disclosure is not limited thereto.

According to exemplary embodiments, the process 1800 may further include implementing the unified framework module in a manner such that the unified framework module is configured to collect, process, enrich, validate, and distribute explicit and implicit feedback of all types from a plurality of applications agnostic to use case and contexts.

According to exemplary embodiments, the UFD 402 may include a memory (e.g., a memory 106 as illustrated in FIG. 1) which may be a non-transitory computer readable medium that may be configured to store instructions for implementing a platform and language agnostic UFM 406 for collecting, processing, enriching, validating, and distributing explicit and implicit feedback of all types from any software application agnostic to use case and contexts as disclosed herein. The UFD 402 may also include a medium reader (e.g., a medium reader 112 as illustrated in FIG. 1) which may be configured to read any one or more sets of instructions, e.g., software, from any of the memories described herein. The instructions, when executed by a processor embedded within the UFM 406, 506 or within the UFD 402, may be used to perform one or more of the methods and processes as described herein. In a particular embodiment, the instructions may reside completely, or at least partially, within the memory 106, the medium reader 112, and/or the processor 104 (see FIG. 1) during execution by the UFD 402.

According to exemplary embodiments, the instructions, when executed, may cause a processor embedded within the UFM 406 or the UFD 402 to perform the following: creating an ontology that includes mapping of application level details where all fields are being used in capturing data; encoding each field's contextual information using an ontology structure surrounding the field in the ontology; receiving a query from an application to collect feedback data from a particular field within the ontology; analyzing the query and traversing up ontology branches of the ontology structure to create one or more feedback collection schemas to allow rich context collection based on the received query; collecting the feedback data from the particular field based on the one or more feedback collection schemas; assigning the collected feedback data an event under a topic for consumption; and subscribing to the event and consuming the feedback data under the topic as requested by an end user. According to exemplary embodiments, the processor may be the same or similar to the processor 104 as illustrated in FIG. 1 or the processor embedded within UFD 202, UFD 302, UFD 402, and UFM 406.

According to exemplary embodiments, the instructions, when executed, may cause the processor 104 to further perform the following: generating a machine learning model that learns a set of features and a list of fields that allow the end user to provide input regarding additional fields the end user wants to see corresponding to the application.

According to exemplary embodiments, the instructions, when executed, may cause the processor 104 to further perform the following: curating and maintaining a set of fields that the end user wants to see in a predefined tabular view.

According to exemplary embodiments, the instructions, when executed, may cause the processor 104 to further perform the following: receiving inputs that mention the set of fields and corresponding chart or view or analysis the end user wants to see.

According to exemplary embodiments, the instructions, when executed, may cause the processor 104 to further perform the following: collecting the feedback data for a predefined domain based on the one or more feedback collection schemas.

According to exemplary embodiments, the instructions, when executed, may cause the processor 104 to further perform the following: validating the feedback data by implementing one or more of the following validation processes: manual validation process; rule based validation process; and artificial intelligence or machine learning based process, but the disclosure is not limited thereto.

According to exemplary embodiments, the instructions, when executed, may cause the processor 104 to further perform the following: implementing the unified framework module in a manner such that the unified framework module is configured to collect, process, enrich, validate, and distribute explicit and implicit feedback of all types from a plurality of applications agnostic to use case and contexts.

According to exemplary embodiments as disclosed above in FIGS. 1-18, technical improvements effected by the instant disclosure may include a platform for implementing a platform and language agnostic unified framework module configured to collect, process, enrich, validate, and distribute explicit and implicit feedback of all types from any software application agnostic to use case and contexts, but the disclosure is not limited thereto. For example, according to exemplary embodiments as disclosed above in FIGS. 1-18, technical improvements effected by the instant disclosure may include a platform for implementing a platform and language agnostic unified framework module configured to create a framework that systematically builds context for all feedback collected; give feedback collectors and processors tools to configure the depth of context based on the demands of their use cases; support mandatory and optional feedback content that is configurable by the collector or the processor; provide flexible feedback validation solutions (i.e., manual, rules-based, ML/AI-based (to reduce biases)); introduce distributed manual review feedback workflows; provide an ecosystem where feedback data can be compared against external reference data before being decided upon; make feedback available in real time while allowing consumers to process them in any mode i.e., real time, batch etc., but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for implementing a unified framework module by utilizing one or more processors along with allocated memory, the method comprising:
creating an ontology that includes mapping of application level details where all fields are being used in capturing data;
encoding each field's contextual information using an ontology structure surrounding the field in the ontology;
receiving a query from an application to collect feedback data from a particular field within the ontology;
analyzing the query and traversing up ontology branches of the ontology structure to create one or more feedback collection schemas to allow rich context collection based on the received query;
collecting the feedback data from the particular field based on the one or more feedback collection schemas;
assigning the collected feedback data an event under a topic for consumption; and
subscribing to the event and consuming the feedback data under the topic as requested by an end user.

2. The method according to claim 1, further comprising:
generating a machine learning model that learns a set of features and a list of fields that allow the end user to provide input regarding additional fields the end user wants to see corresponding to the application.

3. The method according to claim 2, further comprising:
curating and maintaining a set of fields that the end user wants to see in a predefined tabular view.

4. The method according to claim 3, further comprising:
receiving inputs that mention the set of fields and corresponding chart or view or analysis the end user wants to see.

5. The method according to claim 1, further comprising:
collecting the feedback data for a predefined domain based on the one or more feedback collection schemas.

6. The method according to claim 5, wherein the application or sub-application utilizes the one or more of feedback collection schemas based on the domain of the feedback collected under a specific context.

7. The method according to claim 6, wherein the specific context includes one or more of the following contexts: ontology based context, application context, and personal context.

8. The method according to claim 1, further comprising:
validating the feedback data by implementing one or more of the following validation processes: manual validation process; rule based validation process; and artificial intelligence or machine learning based process.

9. The method according to claim 1, further comprising:
implementing the unified framework module in a manner such that the unified framework module is configured to collect, process, enrich, validate, and distribute explicit and implicit feedback of all types from a plurality of applications agnostic to use case and contexts.

10. A system for implementing a unified framework module, the system comprising:
a processor; and
a memory operatively connected to the processor via a communication interface, the memory storing computer readable instructions, when executed, causes the processor to:
create an ontology that includes mapping of application level details where all fields are being used in capturing data;
encode each field's contextual information using an ontology structure surrounding the field in the ontology;
receive a query from an application to collect feedback data from a particular field within the ontology;
analyze the query and traverse up ontology branches of the ontology structure to create one or more feedback collection schemas to allow rich context collection based on the received query;
collect the feedback data from the particular field based on the one or more feedback collection schemas;
assign the collected feedback data an event under a topic for consumption; and
subscribe to the event and consume the feedback data under the topic as requested by an end user.

11. The system according to claim 10, wherein the processor is further configured to:
generate a machine learning model that learns a set of features and a list of fields that allow the end user to provide input regarding additional fields the end user wants to see corresponding to the application.

12. The system according to claim 11, wherein the processor is further configured to:
curate and maintain a set of fields that the end user wants to see in a predefined tabular view.

13. The system according to claim 12, wherein the processor is further configured to:
receive inputs that mention the set of fields and corresponding chart or view or analysis the end user wants to see.

14. The system according to claim 10, wherein the processor is further configured to:
collect the feedback data for a predefined domain based on the one or more feedback collection schemas.

15. The system according to claim 14, wherein the application or sub-application utilizes the one or more of feedback collection schemas based on the domain of the feedback collected under a specific context.

16. The system according to claim 15, wherein the specific context includes one or more of the following contexts: ontology based context, application context, and personal context.

17. The system according to claim 10, wherein the processor is further configured to:
validate the feedback data by implementing one or more of the following validation processes: manual validation process; rule based validation process; and artificial intelligence or machine learning based process.

18. The system according to claim 10, wherein the processor is further configured to:
implement the unified framework module in a manner such that the unified framework module is configured to collect, process, enrich, validate, and distribute explicit and implicit feedback of all types from a plurality of applications agnostic to use case and contexts.

19. A non-transitory computer readable medium configured to store instructions for implementing a unified framework module, the instructions, when executed by a processor, causes the processor to perform the following:
creating an ontology that includes mapping of application level details where all fields are being used in capturing data;
encoding each field's contextual information using an ontology structure surrounding the field in the ontology;
receiving a query from an application to collect feedback data from a particular field within the ontology;
analyzing the query and traversing up ontology branches of the ontology structure to create one or more feedback collection schemas to allow rich context collection based on the received query;
collecting the feedback data from the particular field based on the one or more feedback collection schemas;
assigning the collected feedback data an event under a topic for consumption; and subscribing to the event and consuming the feedback data under the topic as requested by an end user.

20. The non-transitory computer readable medium according to claim 19, wherein the instructions, when executed, further causes the processor to perform the following:
generating a machine learning model that learns a set of features and a list of fields that allow the end user to provide input regarding additional fields the end user wants to see corresponding to the application.
